(19) United States
(12) Patent Application Publication
(10) Pub. No.: US 2026/0283875 A1
(43) Pub. Date: Sep. 24, 2026

(54) RISING-ASSISTANCE DEVICE

(71) Applicant: Arkietech Engineering Company, Tainan City (TW)

(72) Inventors: SHU-HUI CHANG, Tainan City (TW); KUO-HSIUNG CHANG, Tainan City (TW)

(21) Appl. No.: 19/398,756

(22) Filed: Nov. 24, 2025

(30) Foreign Application Priority Data
Mar. 21, 2025 (TW) 114110798
Mar. 21, 2025 (TW) 114202845

(51) Int. Cl. A61G 5/14

(52) U.S. Cl. CPC A61G 5/14

(57) ABSTRACT

A rising-assistance device primarily comprises a connecting tube having a bottom end fixed to an immovable fixed location external to the rising-assistance device, a handle is connected to a top end of the connecting tube, and a pivoting mechanism is configured to connect a bottom end of the handle and the top end of the connecting tube, thereby allowing the handle to rotate as needed. Through the configurations, the rising-assistance device allows a user to grasp the handle and apply force when rising from a reclining or lying position so that the user can rise more easily.

### BACKGROUND OF THE INVENTION

The present invention relates to a rising-assistance device allowing a user to grasp and apply force when rising from a reclining or lying position, thereby enabling the user to rise easily.

### DESCRIPTION OF THE RELATED ART

Accordingly, many elderly individuals, persons with poor cardiopulmonary function or those who are obese and physically weak often experience breathing difficulties or discomfort when lying flat on the beds. As a compromise, they may choose to sleep on a reclining chair. However, a limited space of the reclining chair will cause strenuousness and inconvenience to the user when rising without a structure available to grasp and apply force.

In view of the afore-mentioned deficiencies of the user rising from a reclined position, the inventor has made an improvement and thereby developing the present invention.

### T SUMMARY OF THE INVENTION

Accordingly, the primary objective of the present invention is to provide a rising-assistance device allowing a user to grasp a handle to apply force when rising from a lying position, thereby enabling the user to rise more easily.

The main feature of the present invention is related to the rising-assistance device provided with a connecting tube and a bottom end of the connecting tube is fixed to an immovable stationary location external to the rising-assistance device. A handle is connected to a top end of the connecting tube and a pivoting mechanism is installed between the bottom end of the handle and the top end of the connecting tube, thereby enabling the handle to rotate in a desired direction as needed. By means of the arrangements, the rising-assistance device allows a user to grasp the handle and apply force when rising from a lying position, thereby enabling the user to rise more easily.

For better understanding of the technical means to achieve the above object and the effects of the present invention to be accomplished, detailed descriptions are provided below with respect to the following preferred embodiment and with reference to the accompanying figures.

### BRIEF DESCRIPTION OF THE DRAWINGS

FIG. 1 shows a perspective of the first embodiment of the rising-assistance device.

FIG. 2 is an exploded perspective view of the first embodiment of the rising-assistance device.

FIG. 3 is a front view of the first embodiment of the rising-assistance device.

FIG. 4 is a front view of the first embodiment showing the handle rotating in 90 degrees of the rising-assistance device.

FIG. 5 shows a perspective of the first embodiment of the dual handles of the rising-assistance device.

FIG. 6 is a diagrammatical view showing the rising-assistance device placed on a chair.

FIG. 7 shows a perspective of the second embodiment of the rising-assistance device.

FIG. 8 is an exploded perspective view of the second embodiment of the rising-assistance device.

FIG. 9 shows a perspective of the third embodiment of the rising-assistance device.

FIG. 10 shows a perspective of the fourth embodiment of the rising-assistance device.

FIG. 11 shows a perspective of the fifth embodiment of the rising-assistance device.

FIG. 12 is a partial exploded view of FIG. 11.

FIG. 13 is a sectional view of A-A cutting line of FIG. 11.

FIG. 14 is a diagrammatical view showing the fifth embodiment of the rising-assistance device placed on a chair.

### DETAILED DESCRIPTION OF EMBODIMENTS OF THE INVENTION

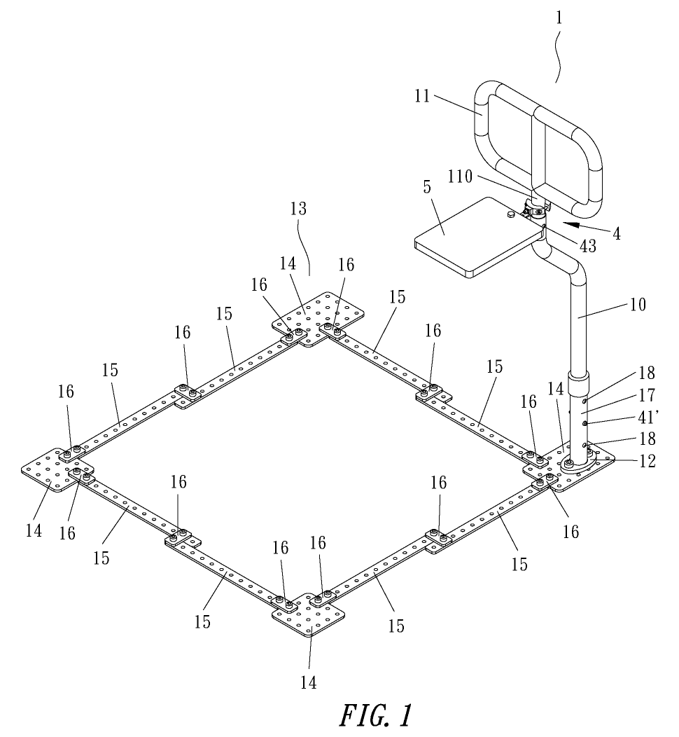

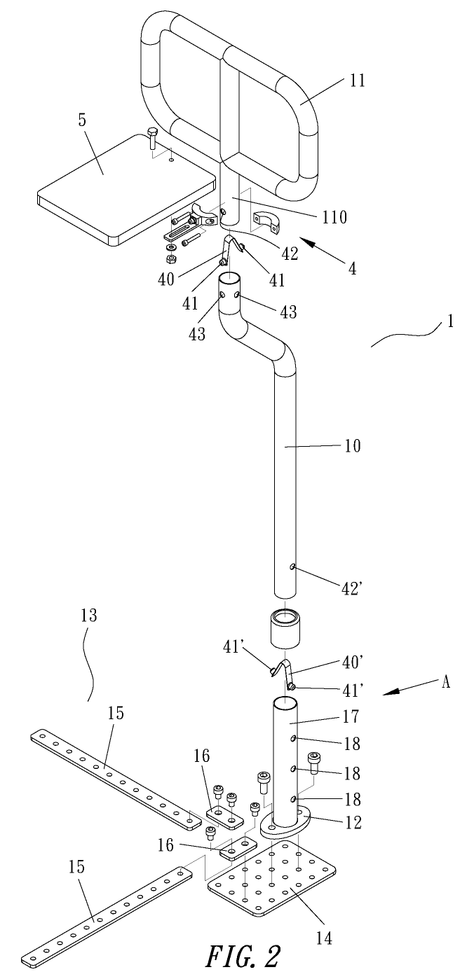

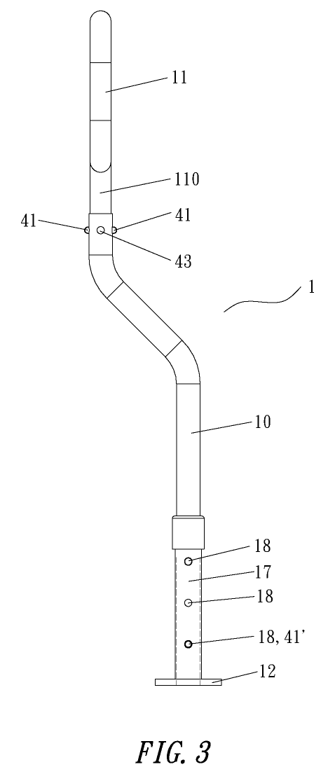

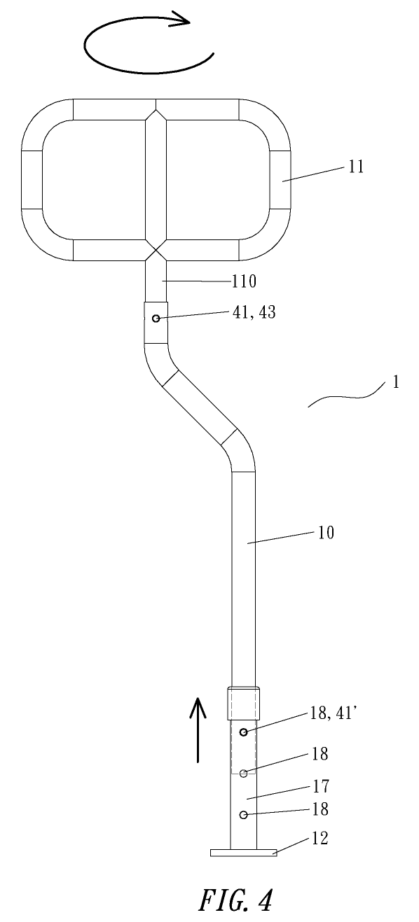

The relevant structural views of the first embodiment are as shown in FIGS. 1 to 4. The rising-assistance device 1 of the present invention comprises a connecting tube 10, wherein a bottom end of the connecting tube 10 is fixed to an immovable stationary location external to the rising-assistance device 1, such as being pressed and fixed by a chair leg. A handle 11 is connected to a top end of the connecting tube 10 and a pivoting mechanism 4 is provided between the bottom end of the handle 11 and the top end of the connecting tube 10, thereby adjusting the rotating direction of the handle 11 according to the demands to allow the user to grasp conveniently.

The pivoting mechanism 4 comprises a handle lower tube 110 installed at the bottom end of the handle, the handle lower tube 110 is inserted into the interior of the top end of the connecting tube 10, a V-shaped spring snap 40 is positioned inside the handle lower tube 110, and two positioning balls 41 are respectively disposed at the two outwardly expanded ends of the V-shaped spring snap. The tube wall of the handle lower tube 110 is provided with radially arranged ball hole 42 at the location corresponding to the two positioning balls 41, wherein the ball hole 42 can allow the outer spherical surfaces of the positioning balls 41 to expose outside the handle lower tube 110, and the tube wall of the connecting tube 10 is provided with annularly arranged positioning holes 43 at the locations corresponding to the positioning balls 41 and the positioning holes 43 are arranged opposite each other in a left-right manner.

The bottom end of the connecting tube 10 is inserted into the interior of the top end f a connecting lower tube 17, and a length adjusting device A is configured at a coupling location of the bottom end of the connecting tube 10 and the connecting lower tube 17. The length adjusting device A is to install the V-shaped spring snap 40’ as the said pivoting mechanism 4 inside the bottom end of the connecting tube 10 and two positioning balls 41’ respectively disposed at the two outwardly expanded ends of the V-shaped spring snap 40’. The tube wall of the bottom end of the connecting tube 10 is provided with radially arranged ball hole 42’ at the location corresponding to the two positioning balls 41’, wherein the ball hole 42’ can allow the outer spherical surfaces of the positioning balls 41’ to expose outside the tube wall of the bottom end of the connecting tube 10. The tube wall of the connecting lower tube 17 is provided with a plurality of positioning holes 18 arranged axially and symmetrically in a left-right opposing manner at the locations corresponding to the positioning balls 41’.

A base 12 is fixed to the connecting tube 10 or the bottom end of the connecting lower tube 17, wherein the base 12 is connected to a baseplate 13 extending outward. The baseplate 13 is composed of a plurality of corner plates 14, a plurality of long plate strips 15 and a plurality of small jointing plates 16, wherein two adjacent corner plates 14 are connected by the long plate strips 15 and the small jointing plates 16 are used to secure the corner plates 14 and the long plate strips 15 via the screw pieces. The top surfaces of the corner plates 14 are configured to be pressed and fixed by the legs of a chair on which the user sits or reclines.

A tray 5 is configured on a side of the handle lower tube 110 and the user can place small items on the tray 5, such as a teacup, a mobile phone or a remote control etc. The tray 5 is pivotally connected to the handle lower tube 110, thereby rotating the tray 5 in a desired direction as needed.

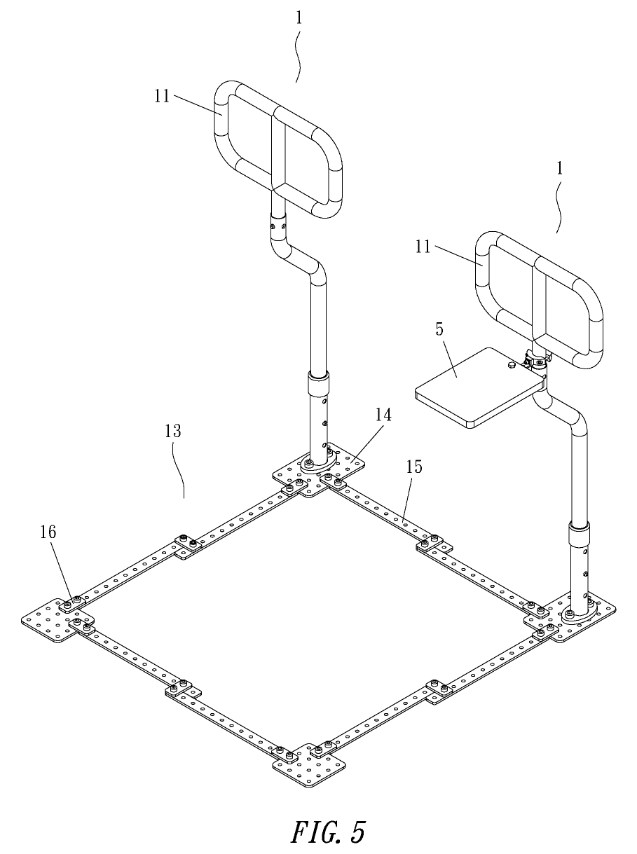

The relevant structures of the first embodiments are as shown in FIG. 5. The rising-assistance devices are respectively installed on the left and right sides of the baseplate13, and therefore the two handles 11 are respectively located on the left and right sides of the chair after the rising-assistance devices are positioned, thereby enabling the user to hold on the two handles 11 to apply force and rise more easily.

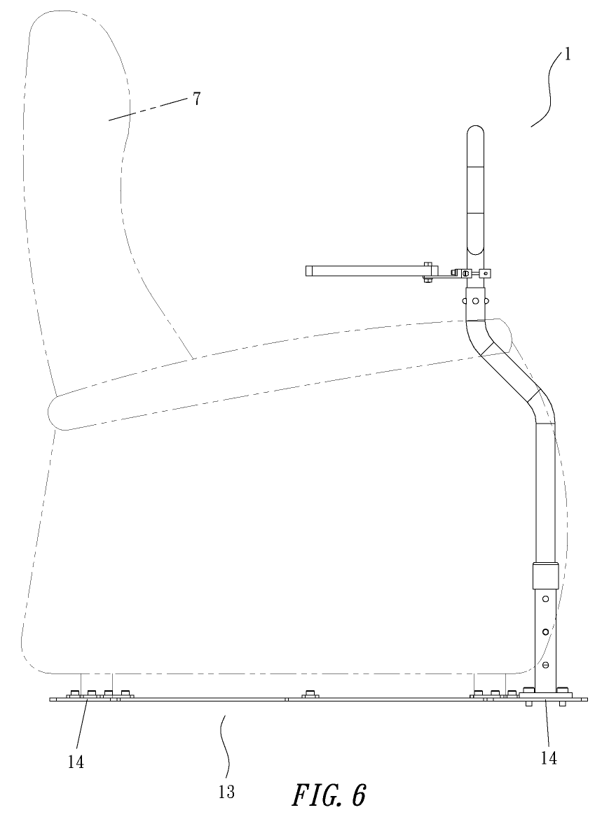

The installation and the relevant structures are shown in FIG. 6. The bottom ends of the four legs of a chair 7 are placed above the four corner plates 14 of the baseplate 13 and the corner plates 14 are fixed by the four legs of the chair 7, thereby enabling the bottom end of the rising-assistance device 1 to be fixed by an immovable stationary location and provide enhanced stability in use.

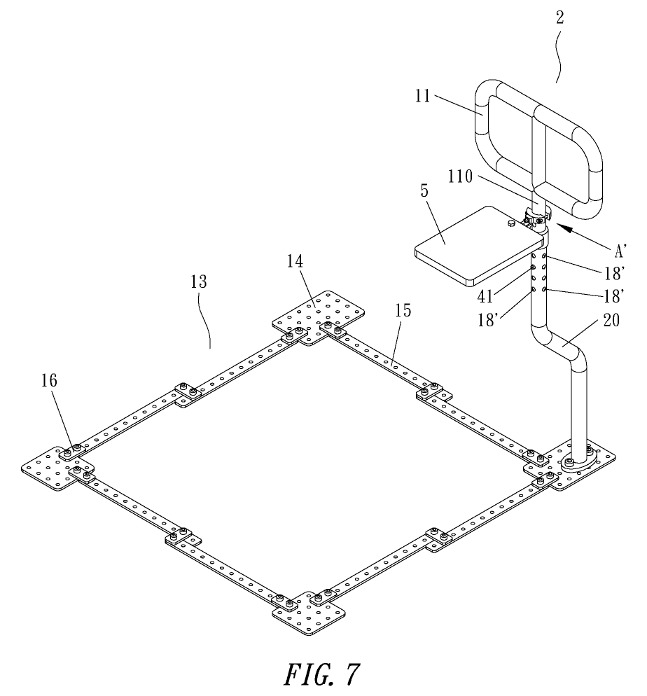

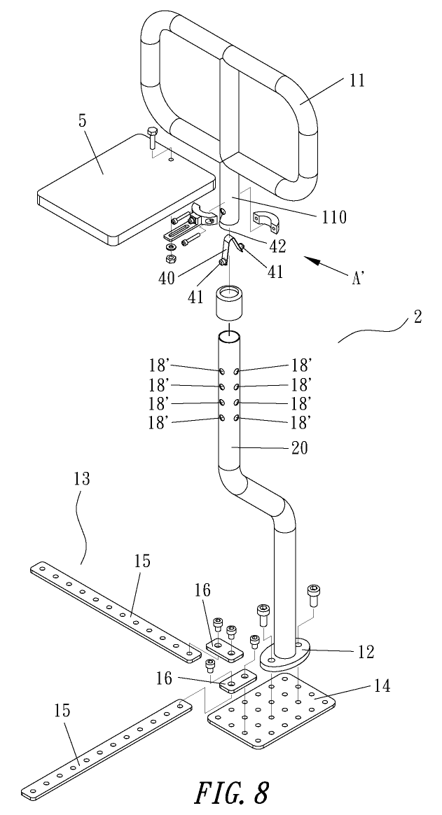

The relevant structures of second embodiment are as shown in FIGS. 7 to 8. Except for having structures similar to those of the rising-assistance device 1 of the first embodiment, the rising-assistance device 2 of the second embodiment differs in that a length adjusting device A’ is installed at a location of the handle lower tube 1110 connecting to the connecting tube 20, and the length adjusting device A’ is to install a V-shaped spring snap 40 inside the bottom end of the handle lower tube 110 and two positioning balls 41 respectively disposed at the two outwardly expanded ends of the V-shaped spring snap 40. The tube wall at the bottom end of the handle lower tube 110 is provided with the radially arranged ball hole 42 at the locations corresponding to the two positioning balls 41, wherein the ball hole 42 can allow the outer spherical surfaces of the positioning balls 41 to expose outside the tube wall of the top end of the handle lower tube 110. The tube wall of the connecting tube 20 is provided with an even number of positioning holes 18’ arranged symmetrically in a left and right manner and extending axially at the locations corresponding to the two positioning balls 41. The positioning holes 18’ allow the handle lower tube 10 to adjust the vertical location and angle and then the positioning balls 41 can be embedded and positioned, thereby enabling to adjust the height of the handle 11 and rotate in a desired angle to be positioned as needed.

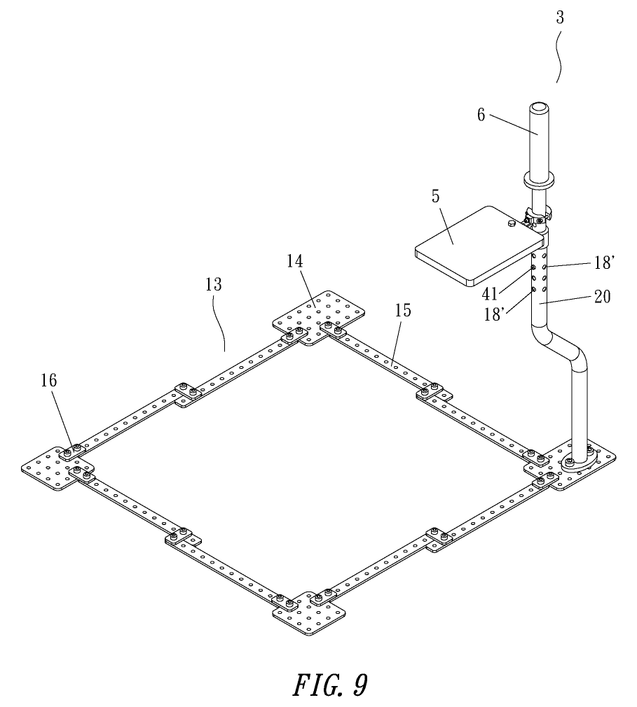

The relevant structures of third embodiment are as shown in FIG. 9. The relevant structures of the rising-assistance device 3 of the third embodiment are similar to the relevant structures of the rising-assistance device 1 of the first embodiment, but the rising-assistance device 3 differs in that a bottom end of a vertical handle 6 is connected to the top end of the connecting tube 20.

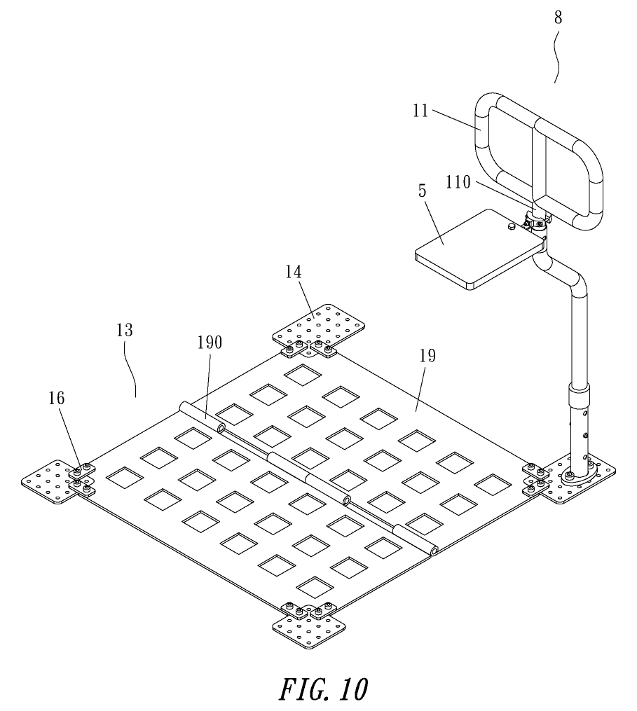

The relevant structures of forth embodiment are as shown in FIG. 10. The relevant structures of the rising-assistance device 8 of forth embodiment are similar to the relevant structures of the rising-assistance device 1 of first embodiment, but the rising-assistance device 8 differs in that the baseplate 13 is composed of a plurality of corner plates 140, a plurality of folding plates and a plurality of small jointing plates 16. The two adjacent folding plates 19 are connected by the hinges 190 and the small jointing plates 16 are used to secure the connecting locations of the corner plates 14 and the folding plates 19 via the screw pieces, thereby securing the corner plates and the folding plates 19. The top surfaces of the corner plates 14 and the folding plates 19 can be pressed and fixed by the four legs of the chair 7 on which the user sits or reclines (similar to FIG. 6).

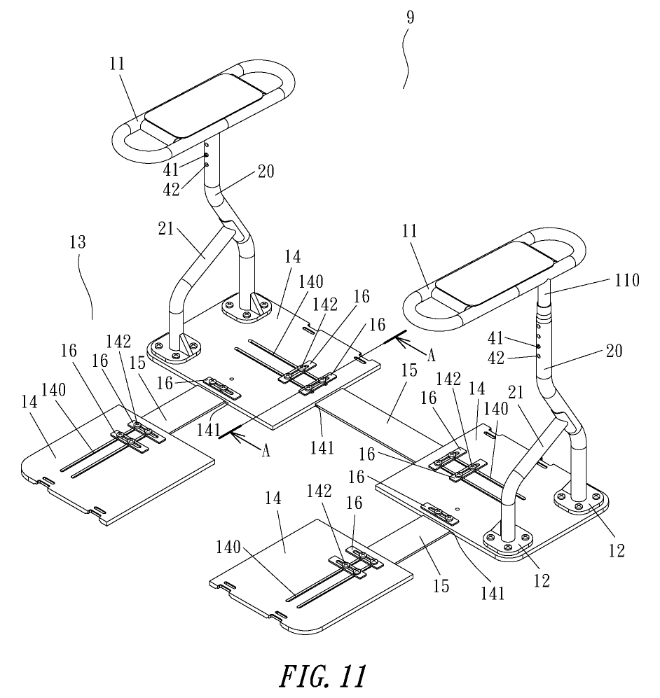

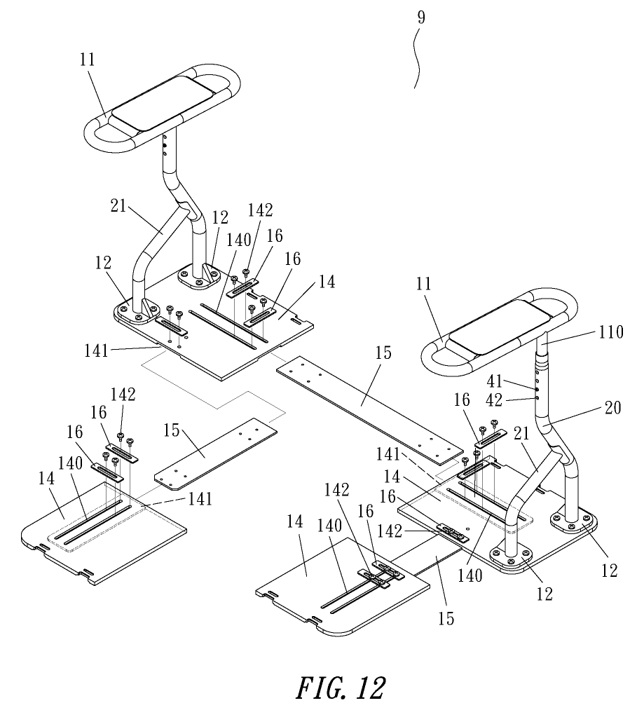

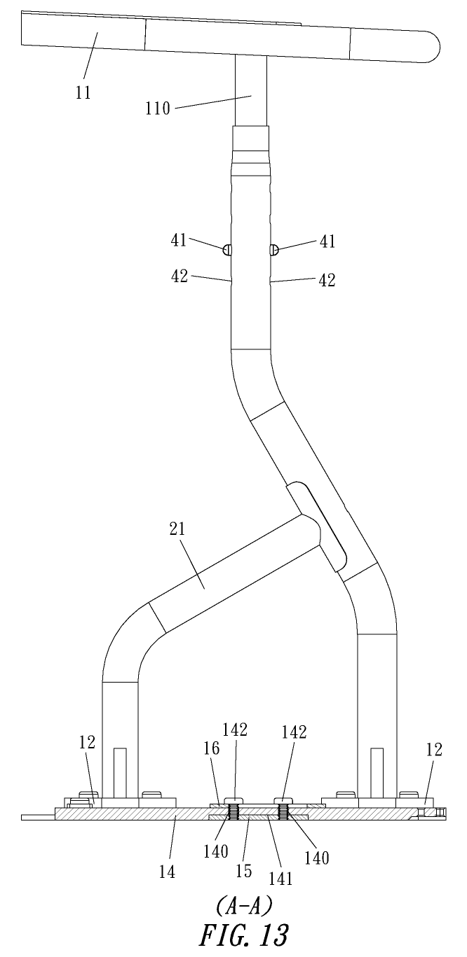

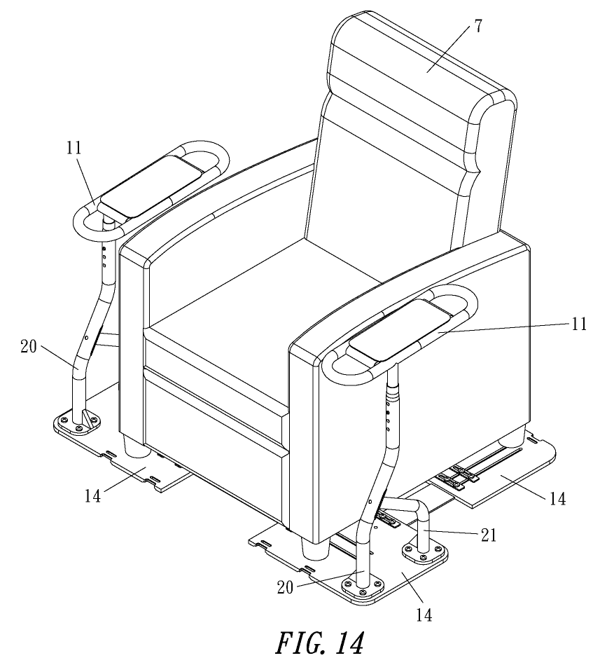

The relevant structures of the fifth embodiment are shown in FIGS. 11 to 14. The relevant structures of the rising-assistance device 9 of the fifth embodiment are similar to the relevant structures of the rising-assistance device 1 of first embodiment, but the rising-assistance device 9 differs in that the corner plates 14 are the flat shapes configured with two parallel and long grooves 140 on the surfaces thereof, and the grooves 140 are extending in the same directions as the long plate strips 15. A upwardly recessed sliding slot 141 is configured at the bottom surface of the corner plate 14 located at the end of connecting to the long plate strip 15 and the location corresponding to the groove 140, and the sliding slot 141 allows the end part of the long plate strip 15 to be embedded and slide to adjust the location. After one end part of the long plate strip 15 is embedded into the sliding slot 141 and the embedding depth is adjusted, the screw piece 142 then penetrates through the small jointing plate 16 and the groove 140 to be fixed with the long plate strip 15, thereby completing the assembly of the corner plate 14 and the long plate strip 15. Moreover, by adjusting the depth of the end part of the long plate strip 15 stretching into the sliding slot 141, the distance between the two adjacent corner plates 14 can be adjusted to adapt to the distance of the legs of the chair used by the user. Therefore, the chair legs rest on each corner plate 14 to press and fix the corner plates. Furthermore, to enhance the stress of the connecting tube 20, a support tube 21 can be connected to the outer wall of the bottom of the connecting tube 20 and the a connecting angle is formed between the support tube 21 and the connecting tube 20, wherein the connecting angle can be an acute angle, so that the support tube 21 increases the supporting strength of the connecting tube 20. A bottom end of the supporting tube 21 and the connecting tube 20 are fixed on the same corner plate 14.

From the above description, the present invention is primarily to utilize a rising-assistance device and by the configurations, the rising-assistance device allows a user to grasp a handle and apply force when rising from a lying position, thereby enabling the user to rise more easily.

In summary, the present invention not only has novelty, but also has value for industrial utilization. Therefore, an application for invention patent is submitted. Your examination and approval will be highly appreciated.

What is claimed is:

1. A rising-assistance device, comprising:
a connecting tube having a bottom end fixed to an immovable fixed location external
to the rising-assistance device;
a handle coupled to a top end of the connecting tube, a bottom end of the handle being
pivotally connected to the top end of the connecting tube through a pivoting mechanism to allow the handle to rotate as needed;
a base connected to a baseplate extending outwardly and the baseplate fixed to the immovable fixed location external to the rising-assistance device, wherein
the baseplate comprising a plurality of corner plates, a plurality of long plate trips and a plurality of small jointing plates;
the two adjacent corner plates being connected by the long plates strip and the small jointing plates being used to secure the corner plates and the long plate strips via the screw pieces at the connecting locations thereof; and,
the top surfaces of the corner plates being configured to be pressed and fixed by the legs of a chair on which a user sitting or lying.

2. The rising-assistance device of claim 1, wherein the pivoting mechanism comprises a
handle lower tube disposed at a bottom end of the handle and inserted into the top end of the connecting tube, a V-shaped spring snap positioned inside the handle lower tube and two positioning balls respectively disposed at the outwardly expanding ends of the V-shaped spring snap, a radial ball hole formed on a tube wall of the handle lower tube corresponding to the positioning balls to allow the outer spherical surfaces of the positioning balls to expose outside the handle lower tube, and the annularly arranged and left-right opposed positioning holes formed on a tube wall of the connecting tube corresponding to the positioning balls.

3. The rising-assistance device of claim 2, wherein the annularly arranged and left-right
opposed positioning holes of the connecting tube are axially extending to align along the connecting tube.

4. The rising-assistance device of claim 1, wherein the bottom end of the connecting tube
is inserted into a top end of a lower connecting tube, a length adjusting device is installed at an jointing location of the connecting tube and the lower connecting tube and the length adjusting device comprises a V-shaped spring snap disposed on the bottom end of the connecting tube and two positioning balls are respectively disposed at outwardly expanding ends of the V-shaped sprig snap, the radial ball hole is configured on a tube wall of the bottom end of the connecting tube corresponding to the two positioning balls, thereby allowing the outer spherical surfaces of the positioning balls to expose outside the tube wall of the bottom end of the connecting tube, and a plurality of axially arranged and left-right symmetrically opposed positioning holes are configured on the tube wall of the lower connecting tube corresponding the positioning balls.

5. A rising-assistance device, comprising:
a connecting tube having a bottom end fixed to an immovable fixed location external
to the rising-assistance device;
a handle coupled to a top end of the connecting tube, a bottom end of the handle being
connected to the top end of the connecting tube through a pivoting mechanism to allow the handle to rotate as needed;
a base connected to a baseplate extending outwardly and the baseplate fixed to the immovable fixed location external to the rising-assistance device, wherein
the baseplate comprising a plurality of corner plates, a plurality of folding plates and a plurality of small jointing plates;
the two folding plates being connected by a hinge and the small jointing plate being used to secure the corner plates and the folding plates via the screw pieces at the connecting locations thereof; and,
the top surfaces of the corner plates and the folding plates being configured to be pressed and fixed by the legs of a chair on which a user sitting or lying.

6. The rising-assistance device of claim 1, wherein the corner plates are flat and provided
with two parallel and long grooves extending in a direction same as the long plate strips on the surfaces thereof, a sliding slot recessed upwardly from the bottom on the bottom surfaces of the corner plates connecting to the ends of the long plate strips and corresponding to the grooves, the end parts of the long plate strips allowed to be embedded into the sliding slots and slide to adjust the positions, and after the end parts of the long plate strips embedded into the sliding slots and adjusting the embedding positions, the screw pieces passing through the small jointing plates and the grooves to be fixed with the long plate strips.

7. The rising-assistance device of claim 2, wherein a tray is provided on a side of the
handle lower tube.

8. The rising-assistance device of claim 1, wherein the rising-assistance devices can be
installed on both left and right sides of the baseplate.

9. The rising-assistance device of claim 6, wherein a supporting tube is connected to an
outer wall of the bottom of the connecting tube, a connecting angle is formed between the supporting tube and the connecting tube and the connecting angle is acute angle, and the supporting tube and the bottom end of the connecting tube are fixed on the same corner plate.
